(19) United States
(12) Patent Application Publication
(10) Pub. No.: US 2006/0272090 A1
(43) Pub. Date: Dec. 7, 2006

(54) Standing station

(76) Inventor: Eric Eugene Woodward, Tigard, OR (US)

Correspondence Address: Eric E. Woodward, 9055 SW Mountain View Lane, Tigard, OR, 97224, US

(21) Appl. No.: 11/144,441

(22) Filed: Jun. 6, 2005

(51) Int. Cl. A61G 7/14

(52) U.S. Cl. 5/86.1; 5/81.1 R

(57) ABSTRACT

The standing station is used as a patient transfer tool, or as a strengthening tool. The standing station uses a leg abutment pad as a weight bearing surface that allows the patient to semi-kneel during transfers and essentially eliminates the risk of patient falls. The standing station uses an ordinary bed sheet to secure the patient. The standing station's wheel mounts do not extend past the back edge of the standing platform so it has unrestricted mobility relative to beds, chairs, wheelchairs and commodes reguardless of their design.

### CROSS-REFERENCE TO RELATED APPLICATIONS

U.S. Pat. No. 6,643,869 Nov. 11, 2003 Sloan, Jr. et al.

U.S. Pat. No. 5,711,044 Jan. 27, 1998 Newman, et al.

U.S. Pat. No. 5,509,152 Apr. 23, 1996 Kippes

U.S. Pat. No. 5,257,425 Nov. 2, 1993 Shinabarger

U.S. Pat. No. 4,918,771 Apr. 24, 1990 James

U.S. Pat. No. 4,435,863 Mar. 13, 1984 Lerich

U.S. Pat. No. 4,279,043 Jul. 21, 1981 Saunders

### STATEMENT REGUARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX (not applicable)

### BACKGROUND OF THE INVENTION

Caregiver injuries and patient falls are a major problem in the health-care industry. In healthcare facilities, assisting weak patients to stand is usually accomplished by pulling the patient up by the arms. If the patient's knees buckle unexpectedly, the patient falls to the floor unless the caregivers are strong enough lower the patient to the floor safely, or carry the patient back to the bed. This scenario frequently results in injuries.

Mechanical lift devices may be available to caregivers, but these devices are used reluctantly for several reasons. They have large bases that are stabile but have limited maneuverability relative to beds, wheelchairs, chairs or commodes. Most mechanical devices put patients in unnatural positions and use strong mechanical forces to lift them. The safety of the patient often relies on the integrity of ropes, chains, belts or slings which is unsettling to patients and their caregivers.

A better solution for moving patients is a portable device that guides the patient into a biomechanically advantageous position for standing up, enhancing the patient's natural ability to stand by providing a bedside environment that creates mechanical advantages. This portable device will be referred to as a “standing station”.

To benefit the patient, the standing station provides a biomechanically advantageous environment at the bedside which:
1. allows the patient to stand with less effort;
2. boosts the patient's confidence which encourages patients to put forth full effort instead of being limited by fear or embarrassment; and
3. provides a means for the patient to benefit from the effects of physical activity with virtually no risk of falling.

To benefit the caregiver, the standing station:
1. allows the caregiver to quickly and easily roll patients from one seating surface to another with essentially no risk of over exertion;
2. moves sideways relative to chairs, wheelchairs, commodes and beds without first moving away from the safety of the seating surface;
3. assumes the correct location when abutted against a bed, chair, wheelchair or commode;
4. requires minimal effort to stabilize the device;
5. allows the caregiver to secure the patient with an ordinary bed sheet;
6. does not need brakes while abutted against chairs, beds, wheelchairs or commodes; and
7. is unimpaired by power cords or other obstacles that are frequently found under hospital beds because the wheels never go under the bed.

The functions described above are achieved by combining the following structural elements:
1. a standing platform at essentially floor level;
2. a leg abutment pad that the patient semi-kneels on;
3. a series of grab bars at graduated distances and heights;
4. a frame and standing platform designed to abut against whatever the patient is sitting on;
5. a wheel mount design that does not extend beyond the back edge of the standing platform;
6. an uppermost section of the frame that serves as both guard rail and grab bar; and
7. a peg on the uppermost section of the frame that allows an ordinary bed-sheet to be used to secure the patient.

In order for an assistive device to be embraced and routinely used by health care providers, it must be easy to use and save time. If it doesn't save time, care providers will choose a quicker solution even if it carries a higher risk of injury. A search of the prior art revealed no devices that possess all of the structural elements that the standing station uses to meet the needs of patients and caregivers.

For example, U.S. Pat. No. 4,279,043 has two major problems. First, the platform the patient stands on is too high above floor level. This makes standing from a chair more difficult. Second, this device can allow the patients knees to buckle unexpectedly.

U.S. Pat. No. 5,257,425 has the same two problems as the previous example plus maneuverability problems caused by an elongated base that extends horizontally outward past the back edge of the standing platform. This base makes it impossible to move the device laterally when it is positioned in front of a chair, bed, wheelchair or commode. The maneuverability of this device would be limited by low bed frames or obstacles found under hospital beds such as power cords and brake levers.

The device in U.S. Pat. No. 6,643,869 B1 employs a recessed standing deck that is closer to floor level but, like the previous examples, has no leg abutment pad and has an elongated base that restricts mobility as described above.

The search revealed mechanical lift devices with leg/knee abutment pads, but they place patients in nonfunctional positions. For example, U.S. Pat. No. 4,918,771 does not allow the patient to lean forward over his/her feet when preparing to stand. This device positions patients incorrectly, and uses strong mechanical forces to overcome this.

The ARJO Encore uses a leg abutment pad and a hydraulic lift arm. It allows some forward leaning, but the leg abutment pad has a strong spring that does not facilitate a forward weight shift when beginning to stand. The Encore raises people in an unnatural position with hydraulic power and requires the patient to have good upper body strength unless belts and straps are used to support the patient's weight.

The ARJO Stedy is a non-motorized transfer device that transports patients in a seated position. To use the ARJO Stedy, the patient pulls his/herself to standing. Once standing, the caregiver positions the flip down seat supports which allow the patient to sit during transport to the new location. The patient must then stand again so the caregiver can flip up the seat supports before the patient can sit at the new location. This is fine for transporting patients longer distances, but cumbersome for quick transfers at the bedside. One problem with the ARJO Stedy is that it's design is geared toward the sitting patient. In other words, the patient is very well supported while sitting on the flip down seat supports, but not while standing. A tall patient could easily lose his/her balance while standing in the device, especially if the brakes are not locked and the device is being moved. It also has an elongated base that prohibits moving sideways without first moving the patient away from the safety of the seating surface. The Arjo Stedy is not designed to abut against the bed or chair so brakes are used and the caregiver must estimate the correct distance at which to lock the brakes. If there is not enough clearance under the bed or chair, the elongated base will not fit under so the device can't be used. If there are power cords or brake levers under the bed, the caregiver would need to divert his/her attention away from the patient and either move the obstacle, or maneuver around it.

All of these devices are radically different from the standing station in structure and function.

### BRIEF SUMMARY OF THE INVENTION

The general idea of this invention is to give the care-provider a compact tool that can roll a semi-kneeling patient from one place to another with minimal risk of injury to either person.

The design of the standing station is based on anatomic, physiologic, kinesiologic, psychologic and mechanical principles. It facilitates human function by strategically placing the following structural elements:

1. a standing platform that is essentially at floor level to maximize mechanical advantage for standing from a standard height chair, bed, wheelchair or commode;

2. a leg abutment pad that allows the patient to semi-kneel and positions the patient's heels near the back edge of the standing platform;

3. a series of grab bars at graduated distances and heights to accommodate different body types, sizes and abilities;

4. a frame and standing platform designed to abut firmly against beds, chairs, wheelchairs and commodes;

5. a wheel mount design that does not protrude past the back edge of the standing platform so the standing station can abut to or move sideways relative to beds, wheelchairs and commodes reguardless of their design;

6. an uppermost section of the frame that serves as both guard rail and grab bar; and

7. a peg on the uppermost section of the frame that allows an ordinary bed sheet to be used to secure the patient.

The standing station is stabilized by only one caregiver to prevent tipping while the patient transitions from sitting to semi-kneeling. Once the patient is semi-kneeling on the device, it is inherently stable and can be rolled to a new location.

### BRIEF DESCRIPTION OF THE SEVERAL VIEWS OF THE DRAWING

Standing Station Eric E. Woodward (503)684-4990

FIG. 1 is a perspective view of the portable standing station that shows the spacial relationship between the standing platform, wheel mounts, leg abutment pad, grab bars, sheet-peg and the uppermost section of the frame.

FIG. 2 is a side elevational view that depicts a caregiver stabilizing the standing station. The semi-kneeling patient is secured from falling backward with an ordinary bed sheet. Once the patient achieves a semi-kneeling position, the standing station is inherently stable.

FIG. 3 is a side elevational view that shows the relationship between the patient and the standing station when the standing station is abutted against a seating surface.

### DETAILED DESCRIPTION OF THE INVENTION

The drawings depict a standing station generally designated 10.

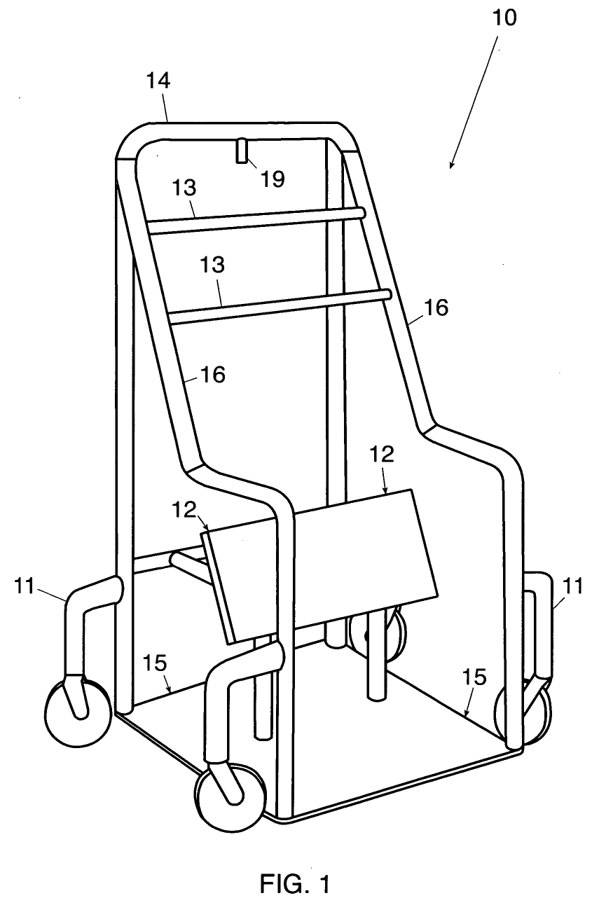

FIG. 1 depicts the preferred embodiment of the standing station 10. The slanted sections of the frame 16 are supporting the grab bars 13. The uppermost section of the frame 14 has a peg 19 that enables the caregiver to secure the patient with an ordinary bedsheet.

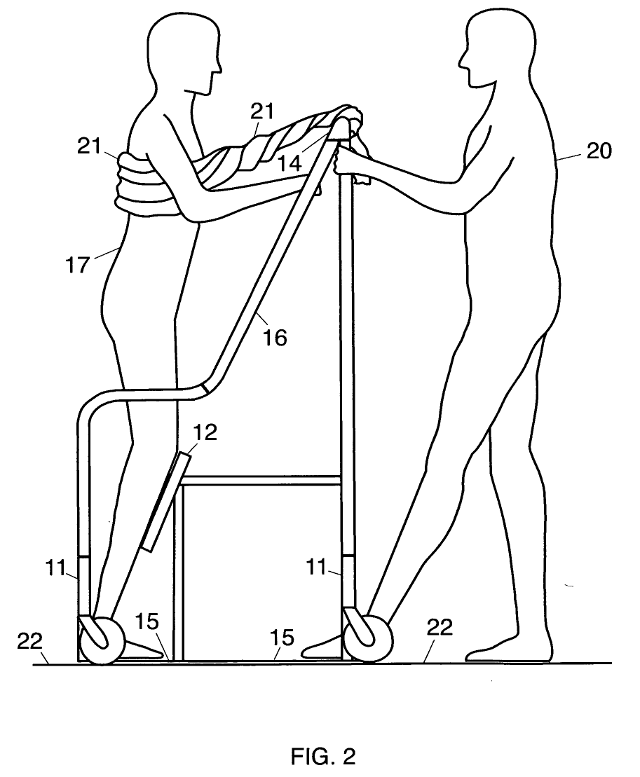

FIG. 2 depicts a patient semi-kneeling on the standing station while the caregiver holds onto the frame of the device and stabilizes it with one foot. The standing platform 15 is essentially at floor level 22, and the wheel mounts 11 do not extend past the back edge of the standing platform. This allows the standing station to be moved sideways relative to chairs, commodes, beds and wheelchairs without moving away from the safety of the seating surface. It also means that the maneuverability of the standing station will be unaffected by power cords, brake levers or other obstacles found under hospital beds. The leg abutment pad 12 allows the patient to shift weight forward over their feet and onto the pad. The leg abutment pad provides a weight bearing surface to semi-kneel on, and directs the patient's heels to the back edge of the standing platform 15. The grab bars 13 are supported by the slanted sections of the frame 16 with the lowest grab bar being closest to the patient. The slanted sections of the frame 16 and the uppermost section of the frame 14 can be used as grab bars as well as guard-rails to prevent loss of control of the semi-kneeling patient 17 while being transported. The uppermost section of the frame 14 has a peg 22 that allows the use of an ordinary bed-sheet 21 to secure the patient. The caregiver 20 stabilizes the standing station by placing one foot on the standing platform 15 while the patient rises from sitting to standing or vice versa.

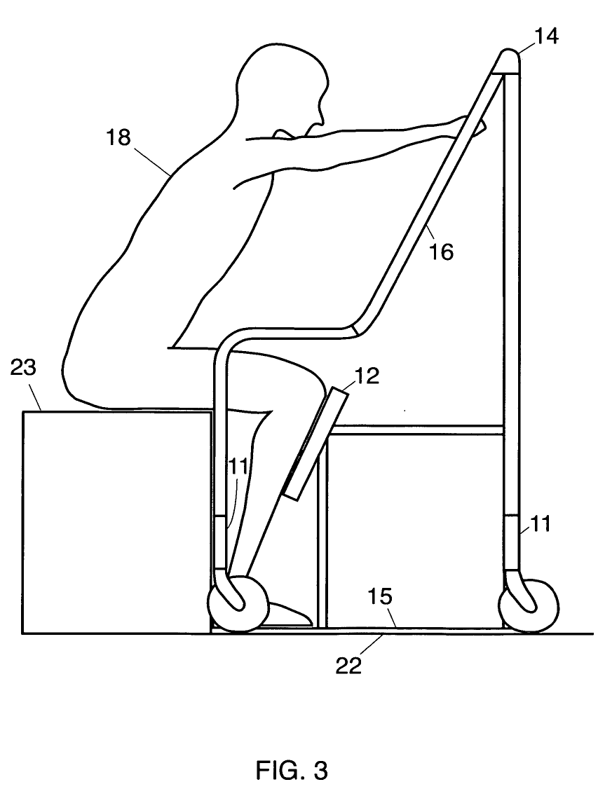

FIG. 3 depicts a standing station 10 abutted against a seating surface 23. The seating surface could be a bed, chair, wheelchair or commode. Note that the wheel mounts 12 do not protrude past the back edge of the standing platform 15 so the standing station 10 can be moved left, right or abutted to the seating surface 23 regardless of what is under the seating surface. It is also important to see that the standing platform 15 is at essentially floor level 22 so standing on the standing station is virtually the same as standing on the floor. This is important because the higher the standing platform is relative to the seating surface, the harder it is for the patient to stand up. When the standing station is abutted against the seating surface 23, the leg abutment pad 12 is the correct distance from the seating surface. The seated patient 18 can easily reach a grab bar, and the device sits him/her far enough back on the bed to insure safety. The patient's legs are supported the entire time by the leg abutment pad to prevent unexpected buckling of the knees.

The standing station can be constructed from any combination of wood, metal or plastic as long as the spacial relationship between the standing platform, leg abutment pad, grab bars, uppermost section of the frame, wheel mounts and the floor is maintained.

To use the device, the caregiver rolls it up to a seated patient, helps the patient put his/her feet on the standing platform, and pushes the device toward the patient until the frame or standing platform abuts firmly against whatever the patient is sitting on. If necessary, a bed-sheet can be used to assist and secure the patient. The sheet is placed around the patient's torso and twisted as depicted in FIG. 2. Twisting the sheet tightens it around the patient's torso and essentially creates a rope that can be used to assist the patient. Each patient would get a fresh sheet so there is no problem with patient to patient cross contamination. The caregiver then assists the patient to scoot forward until their legs contact the leg abutment pad. The caregiver makes sure the patient's heels are near the back edge of the standing platform, and stabilizes the device by applying a downward force to the caregiver side of the device with one foot as shown in FIG. 2. The caregiver's arms are free to assist the patient. The caregiver then instructs the patient to reach for the highest and furthest grab bar or frame section they can comfortably reach. As the patient begins to stand, the caregiver pulls on the sheet. The patient works with the caregiver to get to a semi-kneeling position on the leg abutment pad 12. The caregiver then secures the patient by binding the sheet to the uppermost section of the frame 14. This is accomplished by bringing the sheet over the top of the uppermost section of the frame, then down and around the peg 19 and back up to the uppermost section of the frame. The caregiver holds the end of the sheet in place while gripping the frame, and rolls the patient to a new location with virtually no risk of over exertion. Once in front of the new seating surface, the device is stabilized by the caregiver and the process is reversed as the patient sits down.

When used for therapeutic exercise, the caregiver brings the standing station to the bedside and helps the patient get into the position that is depicted in FIG. 3. The caregiver then stabilizes the device while the patient uses their arms and legs to alternately stand and sit. Extremely weak patients now have a safe way to regain functional strength at the bedside with essentially no risk of falling.

There are many ways to vary the frame design or the sheet binding system without departing from the scope of the invention, the benefits of which have been outlined above. The substance of this invention is the spacial relationship between the standing platform 15, leg abutment pad 12, grab bars 13, wheel mounts 11, uppermost section of the frame 14, peg 19 and floor level 22 as shown in FIGS. 1-3.

1. I claim a standing station which includes:
1. a frame with an uppermost section and two slanted sections that serve as guard-rails and grab bars;
2. grab bars at graduated distances and heights supported by the slanted sections of the frame;
3. a standing platform suspended at essentially floor level by the frame;
4. wheel mounts attached to the frame that do not extend past the back edge of the standing platform to allow unobstructed movement relative to beds, chairs, wheelchairs and commodes;
5. a leg abutment pad affixed to the frame to serve as a weight-bearing surface for the patient to semi-kneel on; and
6. a peg on the uppermost section of the frame that helps bind an ordinary bed-sheet to secure the patient.
